(19) United States
(12) Patent Application Publication
(10) Pub. No.: US 2026/0019186 A1
(43) Pub. Date: Jan. 15, 2026

(54) Optical Switch, and Method of Configuring an Optical Switch

(71) Applicants: Marzio Puleri, Pisa (IT); Luca Giorgi, Pisa (IT)

(72) Inventors: Marzio Puleri, Pisa (IT); Luca Giorgi, Pisa (IT)

(21) Appl. No.: 18/877,295

(22) PCT Filed: Jul. 4, 2022
(86) PCT No.: PCT/EP2022/068491

§ 371 Date: Dec. 20, 2024

(51) Int. Cl. H04J 14/02; H04Q 11/00

(52) U.S. Cl. CPC H04J 14/02122; H04Q 2011/0015; H04Q 2011/0092; H04Q 2011/0098

(57) ABSTRACT

In an example aspect, an optical switch provided. The optical switch comprises a plurality of reconfigurable add/drop multiplexers (ROADMs), each comprising a plurality of optical line ports and a plurality of add/drop ports. The optical switch also comprises a connection apparatus connecting, for each ROADM, each add/drop port of the ROADM to a port of each of a respective one or more other ROADMs. In another example aspect, a method of configuring an optical switch is provided.

### TECHNICAL FIELD

Examples of the present disclosure relate to an optical switch, and a method of configuring an optical switch.

### BACKGROUND

Optical communication networks may use ring and meshed topologies using dense wavelength-division multiplexing (DWDM) systems. Ring topologies are less expensive and easier to implement than meshed topologies, but have limitations in optimal resource allocation and fault identification. A meshed network improves these aspects but are more complex to implement.

Optical meshed networks can be applied to transport networks using the mesh-like fiber infrastructure deployed in metropolitan, regional, national, or international areas using switches operating at wavelength or sub-wavelength level that commutes traffic from an incoming fiber to an outgoing fiber. In ring topologies, each node implements add/drop functionalities and can be connected with only two adjacent nodes, whereas in meshed networks each node may provide connectivity with more than two adjacent nodes, increasing both architecture complexity and cost.

Starting from 5G and evolving towards 6G communication technologies, the optical transport networks supporting these technologies are expected to provide increased capacity and higher performance while keeping the cost and energy consumption lower [1]. DWDM techniques and meshed topologies are a promising solution for networks supporting the radio access network, such as backhaul networks. Furthermore, mesh topologies are one of the preferred choices for high performance computing networks in datacenters.

FIG. 1 shows an example of a radio access network 102 and an optical transport network 104. The optical transport network 104 that can be meshed or a ring. The radio access network 102 is connected to switches 106 in the transport network 104, and another switch 108 is connected to the core network 110.

### SUMMARY

Example embodiments of this disclosure may be simpler, cheaper and more reliable than other optical switching technologies, for example because there may be no use of costly wavelength selective switch elements for the connection apparatus, but instead makes use of passive elements in some examples. Example embodiments may allow an easy implementation of mixed topology networks involving both rings and meshed networks.

One aspect of the present disclosure provides an optical switch comprising a plurality of reconfigurable add/drop multiplexers (ROADMs), each comprising a plurality of optical line ports and a plurality of add/drop ports. The optical switch also comprises a connection apparatus connecting, for each ROADM, each add/drop port of the ROADM to a port of each of a respective one or more other ROADM.

Another aspect of the present disclosure provides a method of configuring an optical switch. The optical switch comprises a plurality of reconfigurable add/drop multiplexers (ROADMs), each comprising a plurality of optical line ports and a plurality of add/drop ports. The optical switch also comprises a connection apparatus connecting, for each ROADM, each add/drop port of the ROADM to a port of each of a respective one or more other ROADMs. The method comprises configuring the ROADMs such that an optical signal provided to an optical line port of a ROADM is provided to one of the optical line ports of a selected one of the respective one or more other ROADMs, and/or configuring the ROADMs such that an optical signal provided to an optical line port of a selected one of the ROADMs is provided to a local termination node connected to an add/drop port of one of the ROADMs, and/or an optical signal from the local termination node is provided to an optical line port of a selected one of the ROADMs.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a radio access network and an optical transport network;

FIG. 2 shows an example of an optical switch according to this disclosure;

FIG. 3 shows an example implementation of an optical switch that includes two ROADMs;

FIG. 4 shows an example implementation of an optical switch that includes three ROADMs;

FIG. 5 shows an example implementation of an optical switch that includes four ROADMs;

FIG. 6 is a flow chart of an example of a method of configuring an optical switch;

FIG. 7 illustrates an example of an optical switch connected to multiple ring networks;

FIG. 8 illustrates an example of interconnection of optical switches; and

FIG. 9 illustrates an example of interconnection of optical switches and ring networks.

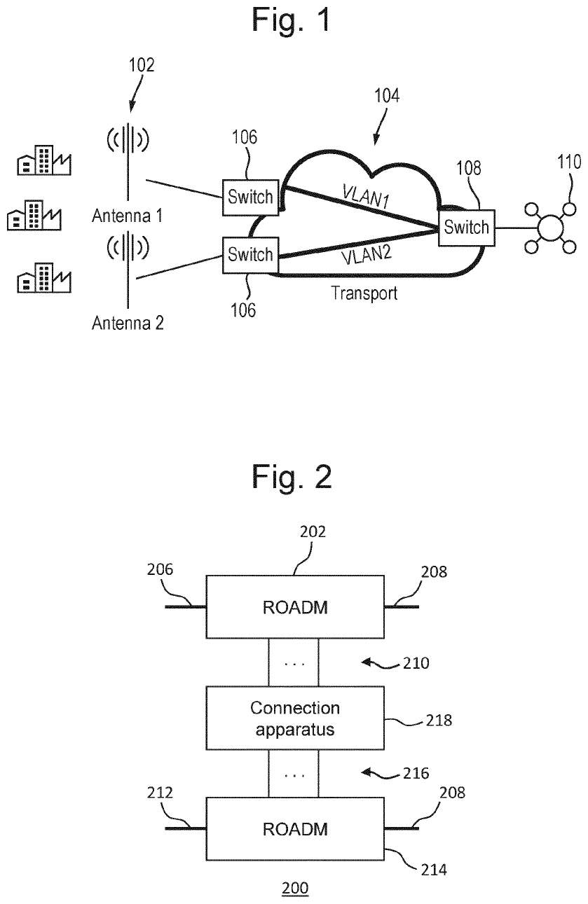

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Higher capacity meshed network topology and DWDM technique are promising technologies, although innovative transmission and switching technologies and techniques may be needed in order to reduce the footprint, cost and complexity and improve energy efficiency.

Example networks according to this disclosure may use nodes, referred to in some examples as Reconfigurable Optical Add/Drop Multiplexers (ROADMs), or an optical switch, that have one or more of the following capabilities:
Add/drop capability: when an optical wavelength channel reaches an optical line port of a node, it could be designated to either stop (be terminated) at the node or pass through the node to another optical line port of the node. The channels that pass through the node are referred to as express channels. In addition, or alternatively, channels could be added to the optical channels passing through the node.
Wavelength switching capability: an optical channel can be flexibly added and dropped allowing dynamic reconfiguration of the node.
Wavelength flexibility capability: any channel is able to reach any adjacent node in the network through the switching function, as long as transmission distance is not an issue.
Multi-degree capability: In a meshed topology, each node can be connected with many adjacent nodes and each degree represents a direction in which the node connects to another node.
Colorless capability: When the wavelength (color) of signals added in a ROADM can be flexibly changed and is not fixed by the physical add/drop port on the node. Colorless capability may be realized for example by providing a tunable wavelength source and by implementing an add/drop structure that is not color specific.
Directionless capability: When a wavelength can be added or dropped from any direction (i.e. from either optical line port).
Contentionless capability: this allows multiple copies of the same wavelength on a single add/drop structure. A contentionless ROADM has no restrictions from the add/drop portion of the ROADM node, so that a transmitter can be assigned to any wavelength as long as the number of channels with the same wavelength is not more than the number of degrees in the node. This guarantees that only one add/drop structure is needed in a node. Network planning may be simplified since any add/drop port can support all colors and connect to any degree.

In a colorless, directionless, and contentionless ROADM implementation, a service can be assigned a color and direction without any restrictions as long as the wavelength color is available at the network level for that direction (e.g. it is possible to allocate the same wavelength on an optical line, but it can only be assigned once per optical line per direction).

Even though particular ROADM implementations may vary based on the design goals in some examples, the basic building blocks may be similar. Differences between node designs may for example reflect the design philosophy and emphasized functionality. As an example, the number of fiber degrees or the number of add/drop ports supported may vary significantly in some examples based on the node architecture and component trade-offs.

In some examples, a ROADM may include the following elements:
A 1×N optical splitter distributes the optical power from the input port to the N output ports. The power splitting ratio among the output ports may be device-dependent in some examples, and may be equally among the N ports for example. The power splitting ratio is generally designed to be wavelength-independent over the operating frequency range of the ROADM. When a splitter is used in the opposite direction, it becomes an optical coupler, where optical signals provided to the N ports are combined and provided to another port. The power loss between a pair of input ports and output ports remains the same in both the splitter and coupler configurations in some examples. An N×N optical coupler is an expanded version of a N×1 optical coupler. For an N×N coupler, the input power at any port on one side of the device is distributed to all ports on the other side of the device with a certain distribution ratio, such as equally for example.
A wavelength splitter (also referred to as a wavelength multiplexer/demultiplexer) is a device to separate optical channels with different wavelengths, or different “colors,” with minimal loss through the device. For example, an arrayed waveguide (AWG) is a device that can separate a group of DWDM channels in one fiber into a set of individual fibers with one channel per fiber.
A tunable filter is a device that allows a wavelength or a range of wavelengths to pass through but blocks all other wavelengths. It is commonly used to select a particular wavelength from a group of wavelengths before an optical receiver. A tunable filter may in some examples provide flexibility in channel selection without the need for optical switching.
A 1×N wavelength selective switch (WSS) is a device that is able to switch a selected wavelength or wavelengths from an input port to a selected one of the N output ports. 1×5 or 1×9 WSSs are typical devices used in ROADM designs today. An M×N WSS is a generalization of a 1×N design and is able to switch a channel or many channels from any input port to any output port, as long as there are no wavelength conflicts (routing multiple copies of the same wavelength to a single output).
A photonic switch provides pure optical signal routing with no conversion of the signal into the electrical domain. A photonic switch may have small port counts, such as 1×2 or 2×2. Photonic switches with large port counts are also useful for node designs. For example, a 320×320 photonic switch with multiple wavelength splitters can provide a flexible add/drop structure for a ROADM node.

The introduction of meshed optical networks, such as for example to support mobile communication networks e.g. 5G and 6G, may require significant cost or the introduction of innovative technologies and solutions to lower the costs. Embodiments of this disclosure may for example not make use of such technologies and solutions, instead providing an optical switch that has low cost, high flexibility and/or high energy efficiency and thus allowing for example meshed optical networks to be implemented at reasonable cost.

Example embodiments of this disclosure provide a network node architecture, such as an optical switch, based on low cost ROADMs, such as for example the ROADMs proposed in [2], interconnected using a connection apparatus or “broadcast matrix”. In some examples, the connection apparatus may be passive, such as for example made up of optical splitting elements. The proposed switch can for example be used both for meshed, ring and mixed topology optical networks. In some examples, the switch may support both bidirectional and unidirectional optical switching at the same time. The latter may be required by the next generation of optical transport networks (e.g. to support 5G and/or 6G mobile networks) for example to optimize network resources usage under the control of Artificial Intelligence (AI) functions.

In some examples, an optical switch may be provided using ROADMs connected back-to-back using a connection apparatus composed by a set of optical splitters connecting the ROADMs add/drop ports in all possible combinations. Each ROADM can be configured to drop on a drop port a lambda (or wavelength or channel) that is then forwarded to all the other ROADMs of the switch. A selected ROADM may add this lambda to the pass-through optical signals, completing the switching operation. Each ROADM may be connected to a ring or to a port of a meshed optical network (e.g. one or more other optical switches). Example embodiments may support the implementation of mixed topology networks involving both rings and meshed networks.

Example embodiments may be simpler, cheaper and more reliable than other optical switching technologies, for example because there may be no use of costly wavelength selective switch elements for the connection apparatus, but instead makes use of passive elements in some examples. Example embodiments may allow an easy implementation of mixed topology networks involving both rings and meshed networks.

FIG. 2 shows an example of an optical switch 200 according to this disclosure. The optical switch 200 comprises a plurality of reconfigurable add/drop multiplexers (ROADMs), each comprising a plurality of optical line ports and a plurality of add/drop ports. In the example shown in FIG. 2, there are two ROADMs 202 and 204, though in other examples there may be three or more ROADMs. ROADM 202 includes two optical line ports 206 and 208, and a plurality of add/drop ports 210. Similarly, ROADM 204 includes two optical line ports 212 and 214 and a plurality of add/drop ports 216. The optical line ports 206, 208, 212 and/or 214 may be connected to or comprise an optical fiber, for example an optical fiber that is part of or connects to another network such as a ring or mesh network, or a node in such a network. Each add/drop port of each of the ROADMs may in some examples be associated with a respective optical wavelength or range of optical wavelengths (or colour or lambda), and this wavelength may be fixed or reconfigurable for an add/drop port.

The optical switch 200 also includes a connection apparatus 218. The connection apparatus 218 connects, for each ROADM, each add/drop port of the ROADM to a port of each of a respective one or more other ROADMs. Thus, for the example shown in FIG. 2, each add/drop port 210 of ROADM 202 is connected to an add/drop port 216 of ROADM 214.

In some examples, each of the two (or more) ROADMs of the optical switch 200 has two line ports (2-degree ROADM), and M local add/drop ports (Ch1, Ch2, . . . , ChM). The ROADM may be for example a 2-degree directionless node able to switch locally up to M different wavelengths. The ROADM may for example be directionless and can be used for bidirectional communication. Each add/drop port acts as wavelength switch and can programmed to drop, to add or bypass the managed wavelength. The wavelength managed at each add/drop port can be locally terminated or sent, by the connection apparatus, to a second ROADM and routed on a different line port of the switch. In some examples, any add/drop port of each ROADM can be connected to the connection apparatus (and thus to another ROADM), or can be terminated locally to provide a signal to and/or receive a signal from a transceiver of a terminating device (e.g. electrical node element).

In some examples, when a drop line is activated on a ROADM, referred to as ROADM-a, its associated lambda is forwarded to the connection apparatus (and in some examples to an optical splitter) that forwards the wavelength to an add port of another ROADM, referred to as ROADM-b. When an add port of ROADM-b is configured to add this lambda, the latter is transmitted over the optical fiber connected to the ROADM-b via one of its optical line ports. In the ROADM-b, at the same time, the same ingress lambda can be dropped and forwarded by the same mechanism to ROADM-a, which adds it to its egress wavelengths. In this way, it is possible in some examples to provide bidirectional connectivity. Unidirectional connections can be also implemented using the same mechanism in some examples. This may be relevant feature for example next generation transport networks where AI functions control automatically and dynamically the resource usage. In other cases, this may allow for example the implementation of optimal bandwidth reservation in case of multipath slices.

In some examples, the ROADMs are configurable such that an optical signal provided to an optical line port of a ROADM is provided to one of the optical line ports of a selected one of the respective one or more other ROADMs. Here, a selected ROADM means for example a ROADM that is chosen through configuration of one or more of the ROADMs. Thus, for example, the ROADMs 202 and 214 may be configured such that a signal that is provided to one of the optical line ports 206, 208, 212 and/or 214 may be provided to any of the other optical line ports. For example, a signal (which may be a wavelength, color or lambda for example) that is provided to optical line port 206 of ROADM 202 may be dropped from one of the add/drop ports and provided via the connection apparatus 218 to one of the add/drop ports 216 of the other ROADM 214. The ROADMs may be reconfigured in some examples such that for example one or more signals provided to line port(s) that are directed by the switch 200 to other port(s) may be directed to different port(s) after the reconfiguration.

In some examples, the connection apparatus may be a passive connection apparatus. So, in some examples, if there are two ROADMs as shown in FIG. 2, the connection apparatus may simply comprise optical apparatus such as optical fibers that connect each add/drop port 210 of ROADM 202 to a respective add/drop port 216 of ROADM 214. In this way, the ROADMs 202 and 214 may be configured such that a signal provided to any of the optical line ports may be directed by ROADMs 202 and 214 to any of the other optical line ports, for example by appropriate configuration of the add and drop functionality of the ROADMs. However, in other examples, there may be three or more ROADMs.

In examples of this disclosure, an optical signal may be for example a wavelength, color or lambda, which may be separated from other optical signals arriving on the same fiber at the same optical line port of a ROADM for example (or a different optical line port on the ROADM for example), and these signals may be provided to the same ROADM (e.g. to different add/drop ports on the same ROADM) and/or to different ROADMs depending on the configuration of the connection apparatus.

In some examples, the connection apparatus connects, for one or more of the ROADMs, each add/drop port of the ROADM to an add/drop port of each of a plurality of other ROADMs. For example, the connection apparatus comprises at least one optical splitter connecting, for each of the one or more of the ROADMs, each add/drop port of the ROADM to an add/drop port of each of the plurality of other ROADMs. In a particular example, a respective optical splitter may be associated with each add/drop port of a first ROADM, whereby the splitter may split an optical signal from the add/drop port and provide that signal to a respective add/drop port of each of the plurality of other ROADMs, which may be all of the other ROADMs or a subset in some examples. Similarly, signals from each of the plurality of other ROADMs may be combined by the splitter and provided to the add/drop port of the first ROADM. It may be the case that only one of the other ROADMS provides a signal on that add/drop port, and thus the splitter may not combine signals but simply provide the signal to the add/drop port of the first ROADM. It is also noted that in some examples, signals can travel in opposite directions, e.g. both to and from the add/drop port of the first ROADM. Each of the other add/drop ports of the first ROADM may also be associated with a respective splitter in a similar manner.

In some examples, the optical splitters may connect together, for each of the one or more of the ROADMs, each add/drop port of the ROADM and the add/drop port of each of the plurality of other ROADMs. Thus, for example, if there are three ROADMs, the connection apparatus may include a respective splitter that is associated with an add/drop port on each ROADM. Thus, for example, for each add/drop port, there may be the same number of splitters as there are ROADMs. Thus, the splitters may be connected in such a way that a port on all of the ROADMs is connected together, and a signal from the port on any ROADM is provided to the add/drop port on the other ROADMs (which may be for example all of the other ROADMS or a subset).

The connection apparatus may in some examples connect, for each ROADM, each add/drop port of the ROADM to a port on each other ROADM. Thus, for example, a signal dropped from any of the add/drop ports of any of the ROADMs is provided to a corresponding add/drop port on all of the other ROADMs. Thus, for example, the ROADMs may be configurable such that a first signal provided to an optical line port of a ROADM can be provided to one of the optical line ports of a selected one of the other ROADMs. This can be achieved for example by including, in the connection apparatus, one splitter associated with each port of each other ROADM, so that for example an optical switch with four ROADMs where each ROADM has eight add/drop ports may have (at least) 32 splitters in the connection apparatus. Thus the interconnection of the ROADMs by the connection apparatus may be achieved using low cost and/or passive components.

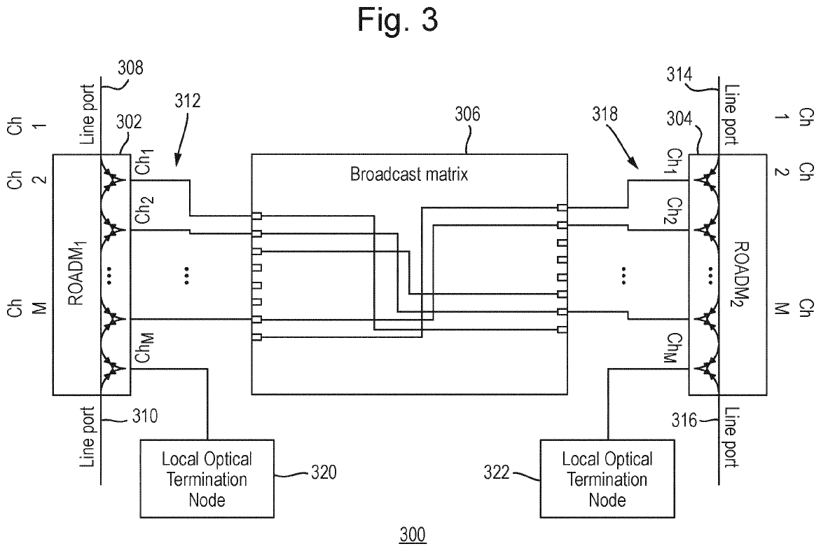

FIG. 3 shows an example implementation of an optical switch 300 that includes two ROADMs 302 and 304 and connection apparatus 306. ROADM includes optical line ports 308 and 310 and add/drop ports 312. Similarly, ROADM 304 includes optical line ports 314 and 316 and add/drop ports 318. A subset of the add/drop ports of each ROADM 302 and 304 are connected to the broadcast matrix, and the broadcast matrix is implemented such that each add/drop port 312 of ROADM 302 is connected to one corresponding add/drop port 318 of ROADM 304. One add/drop port of each ROADM 302, 204 is connected to a respective local termination node 320, 322.

Connecting two ROADMs back-to-back, as shown in the example in FIG. 3, may in some examples provide for example a 4-degree directionless optical switch with the possibility to switch M different wavelengths on the 4 available directions or terminate them locally.

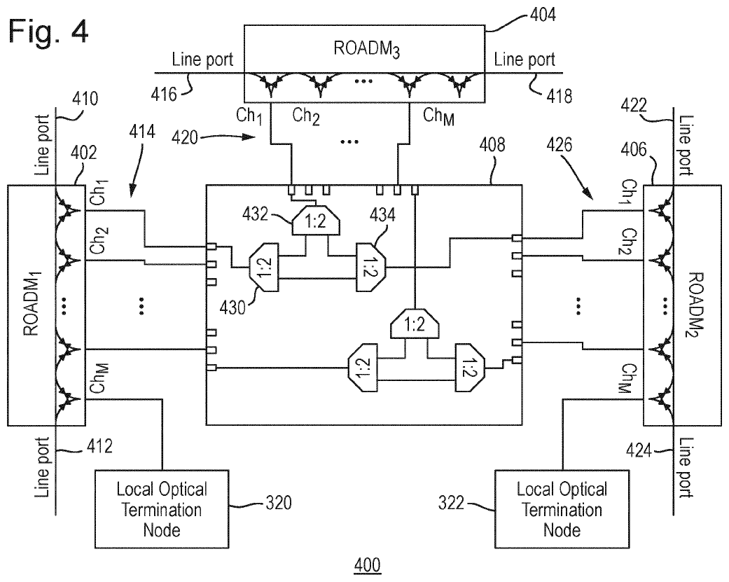

FIG. 4 shows an example implementation of an optical switch 400 that includes three ROADMs 402, 404, 406 and connection apparatus 408. ROADM 402 includes line ports 410 and 412 and add/drop ports 414. ROADM 404 includes line ports 416 and 418 and add/drop ports 420. ROADM 406 includes line ports 422 and 424 and add/drop ports 426. The connection apparatus 408 is configured such that each add/drop port 420 of ROADM 404 is connected to a corresponding add/drop port 414 on ROADM 402 and a corresponding add/drop port 426 on ROADM 406. Additionally, those corresponding add/drop ports on the ROADMs 402 and 406 are also connected together. This is achieved by three optical splitters 430, 432, 434 arranged such that a signal from the add/drop port of any of the ROADMs is provided via two splitters to the corresponding port on each of the other ROADMs. In the example shown, a signal from an add/drop port of one ROADM is split into two signals, and each split signal is provided to a combine input of a respective splitter and then to the add/drop port of one of the other ROADMs. As suggested above, in this example, because there are three ROADMs, there are three splitters for each add/drop port that is interconnected by the connection apparatus 408. However, in the example shown, each of ROADMs 402 and 406 have an additional add/drop port 414, 426 that is connected to a respective local optical termination node 440, 442. In this example, certain optical splitters provide signals from add/drop ports of some ROADMs, though these signals are not connected to an add/drop port of any ROADM. However, in other examples, certain splitter(s) could be arranged or omitted so that unused signals are not produced in this way, for example by omitting one splitter and replacing the 1:N splitters connected to corresponding ports with 1:(N−1) splitters. In this example, this would result in 1:1 splitters, which could instead simply be a direct optical fiber connection between add/drop ports of different ROADMs for example.

Connecting three ROADMs back-to-back interconnected by the non-blocking broadcast matrix, for example as shown in the example in FIG. 4, a 6-degree directionless optical switch may be provided in some examples. Each one of the M different wavelengths can be switched on the 6 available directions (optical line ports) or locally terminated. The connection apparatus may be composed for example of M elementary nodes, each containing three 1:2 splitters/combiners assuring the connection between each of the M wavelengths with each of the 6 line ports of the node.

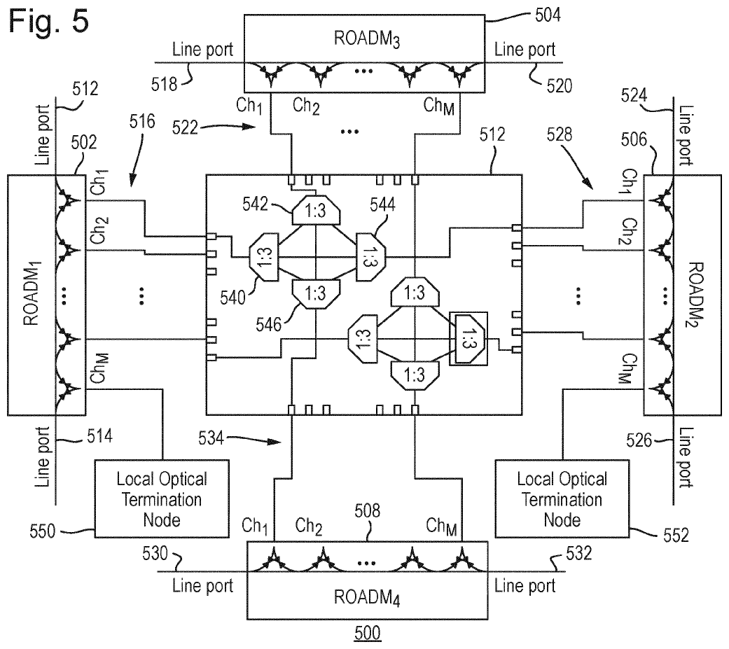

FIG. 5 shows an example implementation of an optical switch 500 that includes four ROADMs 502, 504, 506 and 508 and connection apparatus 510. ROADM 502 includes line ports 512, 514 and add/drop ports 516. ROADM 504 includes line ports 518, 520 and add/drop ports 522. ROADM 506 includes line ports 524, 526 and add/drop ports 528. ROADM 508 includes line ports 530, 532 and add/drop ports 534.

The connection apparatus 512 is configured such that each add/drop port 522 of ROADM 504 is connected to a corresponding add/drop port on the other ROADMs 502, 506 and 508. Additionally, those corresponding add/drop ports on the ROADMs 502, 506 and 508 are also connected together. This is achieved by four optical splitters 540, 542, 544 and 546 arranged such that a signal from the add/drop port of any of the ROADMs is provided via two splitters to the corresponding port on each of the other ROADMs. In the example shown, a signal from an add/drop port of one ROADM is split into three signals, and each split signal is provided to a combine input of a respective splitter and then to the add/drop port of one of the other ROADMs. As suggested above, in this example, because there are four ROADMs, there are four splitters for each add/drop port that is interconnected by the connection apparatus 408. However, in the example shown, each of ROADMs 502 and 506 have an additional add/drop port 516, 528 that is connected to a respective local optical termination node 550, 552. In this example, certain optical splitters provide signals from add/drop ports of some ROADMs, though these signals are not connected to an add/drop port of any ROADM. However, in other examples, certain splitter(s) could be arranged or omitted so that unused signals are not produced in this way, for example by omitting one splitter and replacing the 1:N splitters connected to corresponding ports with 1:(N−1) splitters. In this example, this would result in 1:2 splitters, or 1:1 splitters (or direct optical connections) between add/drop ports of two ROADMs where there are no corresponding add/drop ports on the other ROADMs (i.e. those add/drop ports on the other ROADMs are locally terminated at nodes 550, 552).

In some examples, connecting four ROADMs back-to-back interconnected by the non-blocking connection apparatus as shown for example in FIG. 5 may provide an 8-degree directionless ROADM. Each one of the M wavelengths can for example be switched on the 8 available directions (line ports) or locally terminated. The connection apparatus may for example be composed of M elementary nodes, each containing three 1:3 splitters/combiners assuring the connection between each of the M wavelengths whit each of the 8 line ports of the node.

More generally, in some examples of this disclosure, at least one of the add/drop ports of at least one of the ROADMs is connected to a local termination node. The ROADMs may be configurable for example such that an optical signal provided to an optical line port of a selected one of the ROADMs is provided to the local termination node, and/or an optical signal from the local termination node is provided to an optical line port of a selected one of the ROADMs.

The table below summarizes the relation between the number of ROADMs and the number of splitters/combiners in the “basic element” of the connection apparatus, the basic element being the components that are used to connect together an add/drop port on each of the ROADMs. The degree of node is the number of optical line ports that the optical switch has, although in some examples one or more of the optical line ports may be unused, in which examples signals may not be directed to or from the unused optical line ports.

| | | Number of splitters/ | |
|---|---|---|---|
| | | combiners in the | |
| Degree of | Number of | basic element of the | Splitter/combiner |
| Node | ROADMs | connection apparatus | Ratio |
| 2 | 1 | 0 | none |
| 4 | 2 | 1 | 1:1 |
| 6 | 3 | 3 | 1:2 |
| 8 | 4 | 4 | 1:3 |
| 10 | 5 | 5 | 1:4 |

The optical switch architecture according to example embodiments may thus be easily scalable, acting on the number of ROADMs and on the connection apparatus structure. Increasing the degree of the switch may increase the cost and complexity linearly in some examples.

Where in some examples, each add/drop port of each of the ROADMs is associated with a respective optical wavelength or range of optical wavelengths, which may be reconfigurable in some examples, the ROADMs may be configurable such that for example the add/drop port associated with a first optical wavelength or range of optical wavelengths of at least one of the ROADMs is connected to the add/drop port associated with the first optical wavelength or range of optical wavelengths of at least one other ROADM.

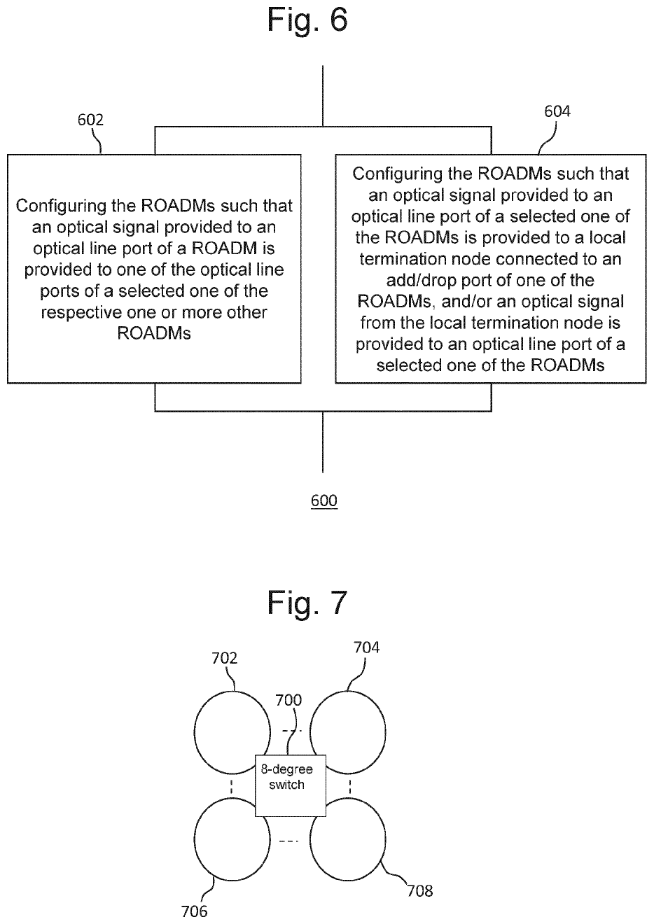

FIG. 6 is a flow chart of an example of a method 600 of configuring an optical switch. The optical switch comprises a plurality of reconfigurable add/drop multiplexers (ROADMs), each comprising a plurality of optical line ports and a plurality of add/drop ports. The optical switch also comprises a connection apparatus connecting, for each ROADM, each add/drop port of the ROADM to a port of each of a respective one or more other ROADMs. The connection apparatus may be a passive optical network for example. In some examples, the optical switch may be any optical switch as described herein, such as for example the optical switch 200 shown in FIG. 2. Thus, some corresponding features of the optical switch may be described in examples of the method described below. In some examples, the optical line ports of at least one of the ROADMs are connected to a ring optical network, and/or at least one of the optical line ports of at least one of the ROADMs is connected to a meshed optical network.

The method 600 comprises, in step 602, configuring the ROADMs such that an optical signal provided to an optical line port of a ROADM is provided to one of the optical line ports of a selected one of the respective one or more other ROADMs. Additionally or alternatively, the method 600 comprises, in step 604, configuring the ROADMs such that an optical signal provided to an optical line port of a selected one of the ROADMs is provided to a local termination node connected to an add/drop port of one of the ROADMs, and/or an optical signal from the local termination node is provided to an optical line port of a selected one of the ROADMs. Thus, in some examples, directing a signal provided to an optical line port of any of the ROADMs and/or an add/drop port (in the case of a locally generated signal) may be provided to any of the optical line ports or an add/drop port (in the case of a locally terminated signal).

In some examples, the method 600 connecting, using the connection apparatus, for one or more of the ROADMs, each add/drop port of the ROADM to an add/drop port of each of a plurality of other ROADMs. The connection apparatus may for example comprise at least one optical splitter connecting, for each of the one or more of the ROADMs, each add/drop port of the ROADM to an add/drop port of each of the plurality of other ROADMs. In some examples, the optical splitters may connect together, for each of the one or more of the ROADMs, each add/drop port of the ROADM and the add/drop port of each of the plurality of other ROADMs. Additionally or alternatively, in some examples, the optical splitters may connect together, for each ROADM, each of one or more add/drop ports of the ROADM and an add/drop port on each other ROADM.

The method 600 may in some examples comprise connecting, using the connection apparatus, for each ROADM, each add/drop port of the ROADM to a port on each other ROADM. The method 600 may also comprise for example configuring the ROADMs such that a first signal provided to an optical line port of a ROADM is provided to one of the optical line ports of a selected one of the other ROADMs.

In some examples, each add/drop port of each of the ROADMs is associated with a respective optical wavelength or range of optical wavelengths. The method 600 may then comprise, for example, configuring the ROADMs to select the respective optical wavelength or range of optical wavelengths associated with at least one add/drop port of at least one of the ROADMs. Additionally or alternatively, the method 600 may then comprise, for example, configuring the ROADMs such that the add/drop port associated with a first optical wavelength or range of optical wavelengths of at least one of the ROADMs is connected to the add/drop port associated with the first optical wavelength or range of optical wavelengths of at least one other ROADM.

Examples of this disclosure provide an optical switch that may be connected to one or more optical networks, including one or more ring networks and/or one or more mesh networks. FIG. 7 illustrates an example of an optical switch 700 connected to multiple ring networks 702, 704, 706 and 708. For example, each ring network may be connected to both optical line ports of one of the ROADMs in the switch 700. Thus for example optical switches as disclosed herein may interconnect the ring networks.

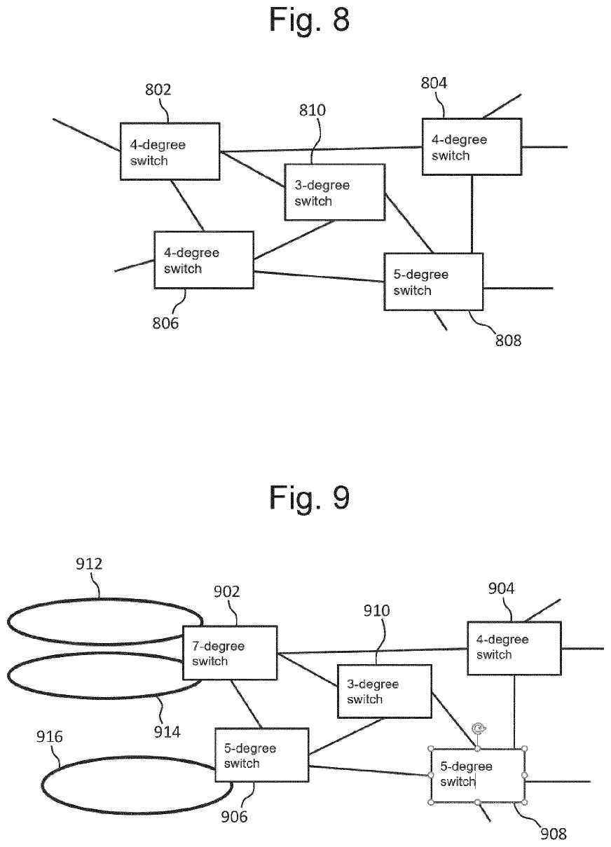

FIG. 8 illustrates an example of interconnection of optical switches 802, 804, 806, 808 and 810. The switches 802, 804, 806 and 808 may also be connected to one or more other optical network(s) (not shown). Optical switches as disclosed herein may thus interconnect networks, and/or may themselves form a mesh network.

FIG. 9 illustrates an example of interconnection of optical switches 902, 904, 906, 908 and 910 and ring networks 912, 914 and 916. Thus, optical switches as disclosed herein may be used to interconnect ring and mesh networks.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. F. Cavaliere, L. Giorgi and L. Potì, “Transmission and Switching Technologies for 5G Transport Networks,” 2018 IEEE Optical Interconnects Conference (OI), Santa Fe, NM, 2018, pp. 47-48.
2. F. Testa et al., “Integrated Reconfigurable Silicon Photonics Switch Matrix in IRIS Project: Technological Achievements and Experimental Results,” in Journal of Lightwave Technology, vol. 37, no. 2, pp. 345-355, 15 Jan. 15, 2019
3. “Transparent Optical Switches: Technology Issues and Challenges”, G. Ellinas et al., Published 2002, Computer Science

1-27. (canceled)

28. An optical switch comprising:
a plurality of reconfigurable add/drop multiplexers (ROADMs), each comprising a plurality of optical line ports and a plurality of add/drop ports; and
a connection apparatus connecting, for each ROADM, each add/drop port of the ROADM to a port of each of a respective one or more other ROADMs.

29. The optical switch of claim 28, wherein the ROADMs are configurable such that an optical signal provided to an optical line port of a ROADM is provided to one of the optical line ports of a selected one of the respective one or more other ROADMs.

30. The optical switch of claim 28, wherein the connection apparatus connects, for one or more of the ROADMs, each add/drop port of the ROADM to an add/drop port of each of a plurality of other ROADMs.

31. The optical switch of claim 30, wherein the connection apparatus comprises at least one optical splitter connecting, for each of the one or more of the ROADMs, each add/drop port of the ROADM to an add/drop port of each of the plurality of other ROADMs.

32. The optical switch of claim 31, wherein the optical splitters connect together, for each of the one or more of the ROADMs, each add/drop port of the ROADM and the add/drop port of each of the plurality of other ROADMs.

33. The optical switch of claim 31, wherein the optical splitters connect together, for each ROADM, each of one or more add/drop ports of the ROADM and an add/drop port on each other ROADM.

34. The optical switch of claim 28 wherein the connection apparatus connects, for each ROADM, each add/drop port of the ROADM to a port on each other ROADM.

35. The optical switch of claim 34, wherein the ROADMs are configurable such that a first signal provided to an optical line port of a ROADM is provided to one of the optical line ports of a selected one of the other ROADMs.

36. The optical switch of claim 28, wherein the connection apparatus is a passive optical network.

37. The optical switch of claim 28, wherein the optical line ports of at least one of the ROADMs are connected to a ring optical network.

38. The optical switch of claim 28, wherein at least one of the optical line ports of at least one of the ROADMs is connected to a meshed optical network.

39. The optical switch of claim 28, wherein at least one of the add/drop ports of at least one of the ROADMs is connected to a local termination node.

40. The optical switch of claim 39, wherein the ROADMs are configurable such that an optical signal provided to an optical line port of a selected one of the ROADMs is provided to the local termination node, and/or an optical signal from the local termination node is provided to an optical line port of a selected one of the ROADMs.

41. The optical switch of claim 28, wherein each add/drop port of each of the ROADMs is associated with a respective optical wavelength or range of optical wavelengths.

42. The optical switch of claim 41, wherein the ROADMs are configurable to select the respective optical wavelength or range of optical wavelengths associated with at least one add/drop port of at least one of the ROADMs.

43. The optical switch of claim 41, wherein the ROADMs are configurable such that the add/drop port associated with a first optical wavelength or range of optical wavelengths of at least one of the ROADMs is connected to the add/drop port associated with the first optical wavelength or range of optical wavelengths of at least one other ROADM.

44. A method of configuring an optical switch having a plurality of reconfigurable add/drop multiplexers (ROADMs), each comprising a plurality of optical line ports and a plurality of add/drop ports, and further having a connection apparatus connecting, for each ROADM, each add/drop port of the ROADM to a port of each of a respective one or more other ROADMs, and wherein the method comprises:
configuring the ROADMs such that an optical signal provided to an optical line port of a ROADM is provided to one of the optical line ports of a selected one of the respective one or more other ROADMs; and/or
configuring the ROADMs such that an optical signal provided to an optical line port of a selected one of the ROADMs is provided to a local termination node connected to an add/drop port of one of the ROADMs, and/or an optical signal from the local termination node is provided to an optical line port of a selected one of the ROADMs.

45. The method of claim 44, comprising connecting, using the connection apparatus, for one or more of the ROADMs, each add/drop port of the ROADM to an add/drop port of each of a plurality of other ROADMs.

46. The method of claim 45, wherein the connection apparatus comprises at least one optical splitter connecting, for each of the one or more of the ROADMs, each add/drop port of the ROADM to an add/drop port of each of the plurality of other ROADMs.

47. The method of claim 46, wherein the optical splitters connect together, for each of the one or more of the ROADMs, each add/drop port of the ROADM and the add/drop port of each of the plurality of other ROADMs.
